(19) United States
(12) Patent Application Publication
(10) Pub. No.: US 2026/0067662 A1
(43) Pub. Date: Mar. 5, 2026

(54) EMERGENCY TELECOMMUNICATIONS SERVICE SMS TRIGGERED CALL

(71) Applicant: T-Mobile USA, Inc., Bellevue, WA (US)

(72) Inventors: Mark J. Bonn, Granite Bay, CA (US); Dominick Mangiardi, Fremont, CA (US); Sean P. Hoelzle, Collegeville, PA (US); Tariq Mohiuddin, Santa Clara, CA (US); John T. Susbilla, Milpitas, CA (US)

(21) Appl. No.: 18/825,674

(22) Filed: Sep. 5, 2024

(51) Int. Cl. H04W 4/90; G10L 17/06; G10L 17/24; H04W 4/14; H04W 76/50

(52) U.S. Cl. CPC H04W 4/90; G10L 17/06; G10L 17/24; H04W 4/14; H04W 76/50

(57) ABSTRACT

Techniques and architecture described herein provide an efficient manner in which to interface with an emergency telecommunications service such as, for example, Government Emergency Telecommunications Service (GETS), from a mobile communication device using a short message service (SMS) embedded application on the mobile communication device to initiate and optimize an emergency telecommunications service call set up. A user opens a native SMS application on their mobile communication device. The user then enters a short code, e.g., GETS, as the destination number of a SMS message. In the SMS message body, the user enters the destination phone number of the party the user is attempting to reach. The user is verified by, for example, a voice biometric passphrase. Upon verification, the user may be connected to destination phone number.

### BACKGROUND

Emergency telecommunications services include, for example, Government Emergency Telecommunications Service (GETS), which is a White House-directed emergency telephone service provided and managed by Cybersecurity and Infrastructure Security Agency (CISA), which is a component of the United States Department of Homeland Security (DHS). GETS provides subscribers with priority end-to-end voice calling with exemption to overload controls, immunity to preemption vulnerabilities, and priority signaling required to setup the voice bearer. GETS Subscribers are issued a 12-Digit Personal Identification Number (PIN) for user authentication and assignment of various calling privileges. Physical GETS cards and usage guides are issued to all subscribers for easy reference. Calls made with GETS overcome network congestion and/or degradation.

Currently, GETS requires a user to dial an access number from their calling device, e.g., a mobile phone or a wireline phone. GETS then requires the user to enter a 12-digit authentication code (PIN). Finally, the user must enter a destination number, e.g., a number to which the user wishes to be connected via their calling device. During high stress responses to manmade or natural disasters by first responders or other emergency support personnel, the GETS call set up is prone to user error due to the 32+ digits that must be entered.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 schematically illustrates an example block diagram of an architecture for a portion of a wireless communication network and a mobile communication device using a short message service (SMS) embedded application on the mobile communication device to initiate and optimize an emergency telecommunications service call set up, according to some implementations.

FIG. 2 is a flow diagram for an example of interfacing with an emergency telecommunications service such as, for example, Government Emergency Telecommunications Service (GETS), from a mobile communication device using a SMS embedded application on the mobile communication device to initiate and optimize an emergency telecommunications service call set up, according to some implementations.

FIG. 3 is a flow diagram illustrating an example method for interfacing with an emergency telecommunications service such as, for example, GETS, from a mobile communication device using a SMS embedded application on the mobile communication device to initiate and optimize an emergency telecommunications service call set up, according to some implementations.

FIG. 4 schematically illustrates a component level view of an example mobile communication device configured for use with the techniques and architecture described herein, according to some implementations.

FIG. 5 schematically illustrates a component level view of a server configured for use with the techniques and architecture described herein, according to some implementations.

### DETAILED DESCRIPTION

Described herein are techniques and architecture that introduce an efficient manner in which to interface with an emergency telecommunications service such as, for example, Government Emergency Telecommunications Service (GETS), from a mobile communication device using a short message service (SMS) embedded application on the mobile communication device to initiate and optimize an emergency telecommunications service call set up. While the techniques and architecture are described herein primarily with respect to GETS, it is to be understood that the techniques and architecture are applicable to other emergency telecommunications services. While the descriptions provided herein may be in the context of SMS messages that are provided by a mobile communication device sent to a SMS center (SMSC) of the wireless communication network, other forms of text messaging may be implemented in other embodiments, such as the use of real-time text (RTT) messages, multimedia messaging service (MMS) messages, etc., that are sent to their respective message service centers of the wireless communication network.

GETS is a calling card program that provides authorized national security and emergency preparedness (NS/EP) users End-To-End Priority Voice calling with high probability of call completion in congested networks. It is a nationwide program providing authorized personnel priority calling during an emergency or crisis situation when the cellular networks are congested and the probability of completing a call is reduced. The GETS priority voice service can be used with common telephone equipment, including standard desk sets, secure telephone equipment, cellular phones, and satellite phones. Calls placed through GETS receive priority and exemption to overload controls over normal public calls, allowing users to communicate even during the highest levels of network. GETS also provides priority calling to cell phones on most major carrier networks. There is no charge to enroll in GETS or to make calls to the familiarization/test line.

GETS leverages existing features of commercial local and long-distance, including wireless networks, telecommunications service networks along with selected enhancements that are developed and implemented in accordance with Federal Communications Commission (FCC) rules and follow industry standards. Carriers complete GETS calls using whatever network facilities are available during an emergency event. GETS calls receive priority treatment only within the domestic phone network in the United States, including its territories.

GETS features include, for example, access to any user via an authentication code (PIN), priority over normal public calls, exemption to overload controls, priority signaling, and immunity to pre-emption.

When a caller dials a GETS access number from a calling device, the local carrier recognizes it as a priority call and processes it using special GETS handling instructions. When the call reaches a GETS service provider, that provider authenticates the call by prompting the caller to enter a 12-digit PIN and the intended destination number. The GETS service provider routes authenticated calls to the termination number using end-to-end priority features deployed within the provider's network. GETS calls terminating in another carrier's network also receive priority treatment on the terminating leg.

Thus, traditionally a GETS user uses a native dialer on their mobile communication device to dial a 10-digit access number. The GETS user then receives a prompt and enters a 12-digit authentication code or PIN via the native dialer. The user then receives a prompt and enters the 10+ digit destination number via the native dialer. Finally, the user will be connected to the destination number via the mobile communication device. During high stress responses to manmade or natural disasters by first responders, the GETS call set up is prone to user error due to the 32+ digits that must be entered via the native dialer.

In accordance with configurations of the present disclosure, the GETS user opens a native SMS application on their mobile communication device. The user then enters a short code, e.g., GETS (which is 4387 on a native dialer or keypad) as the destination number of a SMS message. In the SMS message body, the user enters the destination phone number of the party the user is attempting to reach.

The SMS center (SMSC) receives and routes the SMS message as a session initiation protocol (SIP) MESSAGE to the GETS application server in the Internet Protocol Multimedia Subsystem (IMS) core. The GETS application server extracts the originating phone number (e.g., the MSISDN, or MDN, of the mobile communication device used to originate the SMS message) and the destination number from the body of the SMS message. Upon extracting the destination number, the GETS application server initiates a SIP INVITE to the mobile communication device originating the SMS message.

The GETS user answers the call and receives an announcement that they are using GETS of the mobile operator's wireless communication network. After the announcement, the user may be prompted for their voice biometric passphrase for user authentication. A voice biometric engine authenticates the user based on a voiceprint match of a previously recorded passphrase known as a voiceprint. The GETS application server looks up the user's privileges in a PIN database based on the mobile operator mobile directory number (MDN) associated with the voiceprint. In configurations, the user may be authenticated via some other means, e.g., a fingerprint, facial recognition, etc.

If the user has PIN privileges to dial the destination number, the user receives a final announcement from the GETS application server. After the GETS application server processes the destination number, the GETS user may be connected to the desired destination number.

Since the mobile operator knows the phone number from which the user is calling, the GETS application server may look up the user's privileges in the PIN database based upon the mobile operator MDN. Additionally, the phone number from which the mobile communication device is calling, can also be used to locate the user's voiceprint.

In configurations, the user may be preauthorized for a predetermined amount of time, e.g., for ten days. In some configurations, the preauthorization may be based upon, for example, a predicted natural disaster. For example, a hurricane might be predicted to hit portions of Florida. The user may be preauthorized for a predetermined amount of time required before, during and/or after the anticipated arrival of the hurricane. Based on such preauthorization, the user may just need to dial the destination number. In configurations, the preauthorization may be controlled via a geofence. For example, a geofence may be defined for areas affected by the anticipated hurricane. In order for the preauthorization to be enabled for the user, the user and their mobile communication device must be located within the defined geofence.

Accordingly, as an example, a method comprises providing, by a mobile communication device to a short message service (SMS) center (SMSC) of a wireless communication network, a SMS message, wherein the SMS message comprises a destination for an emergency service application server. The method also comprises based at least in part on an originating phone number of the SMS message and a destination phone number within the SMS message, receiving, by the mobile communication device from the emergency service application server, a session initiation protocol (SIP) message that initiates a verification of a user of the mobile communication device via the mobile communication device. The method further comprises based at least in part on the verification of the user of the mobile communication device, interacting, by the mobile communication device, with a communication device associated with the destination phone number.

In configurations, the emergency service application server is part of Government Emergency Telecommunications Service (GETS).

In some configurations, the method further comprises in response to the SIP message, receiving, by the mobile communication device, an announcement indicating the mobile communication device is accessing GETS of an operator of the wireless communication network.

In configurations, the verification of the user of the mobile communication device comprises comparison of a voice of the user with a passphrase previously recorded by the user.

In some configurations, comparison of the voice of the user with the passphrase previously recorded by the user comprises comparison of the passphrase previously recorded by the user with words annunciated by the user in response to at least an announcement indicating the mobile communication device is accessing Government Emergency Telecommunications Service (GETS) of an operator of the wireless communication network.

In some configurations, the words annunciated by the user in response to at least the announcement comprises the passphrase.

In configurations, interacting, by the mobile communication device, with the communication device associated with the destination phone number is further based at least in part on privileges associated with an authentication code associated with the user.

In configurations, the method further comprises preauthorizing the mobile communication device for a predetermined amount of time for interaction of the mobile communication device with the destination phone number.

In some configurations, preauthorization of the mobile communication device is only valid within a predefined geofence of the wireless communication network.

As another example, a system comprises one or more processors; and one or more non-transitory computer-readable media storing computer-executable instructions that, when executed by the one or more processors, cause the one or more processors to perform actions comprising providing, by a mobile communication device to a message service center (MSC) of a wireless communication network, a text message, wherein the text message comprises a destination for an emergency service application server; based at least in part on an originating phone number of the text message and a destination phone number within the text message, receiving, by the mobile communication device from the emergency service application server, a session initiation protocol (SIP) message that initiates a verification of a user of the mobile communication device via the mobile communication device; and based at least in part on the verification of the user of the mobile communication device, interacting, by the mobile communication device, with a communication device associated with the destination phone number.

As another example, a method comprises providing, by a mobile communication device to a message service center (MSC) of a wireless communication network, a text message, wherein the text message comprises a destination for an emergency service application server, wherein the emergency service application server is part of Government Emergency Telecommunications Service (GETS); based at least in part on an originating phone number of the text message and a destination phone number within the text message, receiving, by the mobile communication device from the emergency service application server, a session initiation protocol (SIP) message that initiates a verification of a user of the mobile communication device via the mobile communication device; in response to the SIP message, receiving, by the mobile communication device, an announcement indicating the mobile communication device is accessing GETS of an operator of the wireless communication network; and based at least in part on the verification of the user of the mobile communication device, interacting, by the mobile communication device, with a communication device associated with the destination phone number, wherein verification of the user of the mobile communication device comprises comparison of a voice of the user with a passphrase previously recorded by the user.

Thus, the techniques and architecture described herein allow a user to easily initiate a high priority call and use their voice to authenticate themselves by speaking a short passphrase, e.g., “I'm a GETS user.” The passphrase may be biometrically compared to a pre-recorded passphrase to ensure authentication of the user based on a voiceprint of the user. The user also has the option of saying any phrase to match their biometric voiceprint. The characteristics of the user's voiceprint may be evaluated for authenticity, not the actual spoke phrase. The techniques and architecture also provide all first responders using GETS an optional interface with an optimized call set-up solution. The goal of GETS is to “increase the probability of call completion during all conditions, i.e., network overloading.” The techniques and architecture provide a new innovative way to initiate a GETS call, thereby minimizing the interactions in authenticating the user through something unique to themselves, e.g., their voice.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

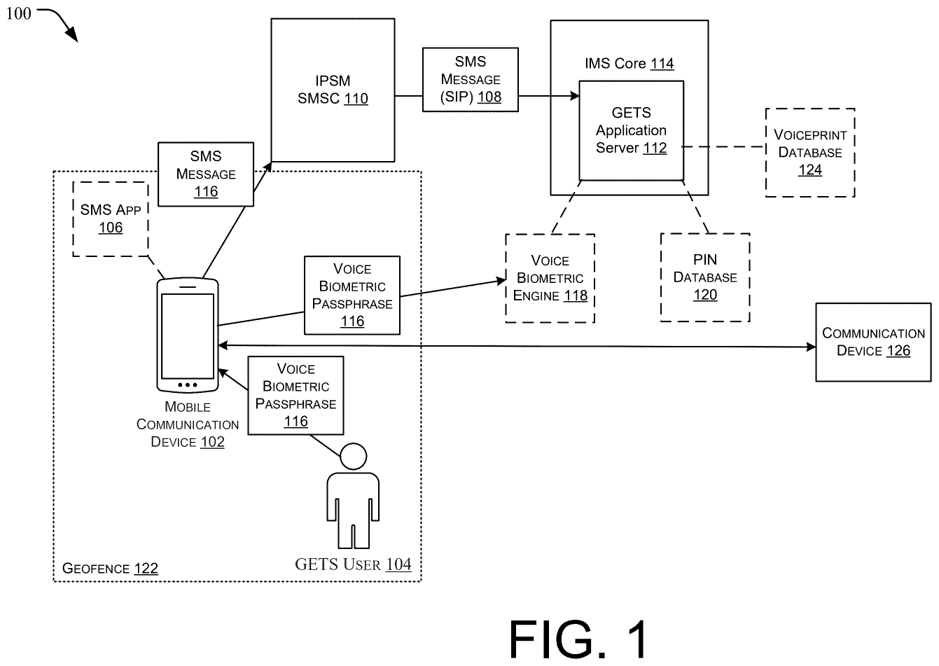

FIG. 1 schematically illustrates an example portion of a wireless communication network 100. A mobile communication device 102, e.g., a smart phone, a television, a smart appliance, a tablet, a personal computer, etc., is configured to operate within the wireless communication network 100. In configurations, the mobile communication device 102 may be used by a user to access an emergency telecommunications service such as, for example, Government Emergency Telecommunications Service (GETS), by a GETS user 104. In configurations, the mobile communication device 102 includes a short message service application 106.

As previously noted, traditionally a GETS user 104 uses a native dialer on their mobile communication device 102 to dial an access number. The GETS user 104 then receives a prompt and enters a 12-digit authentication code or pin via the native dialer. The GETS user 104 then receives a prompt and enters the 10+ digit destination number via the native dialer. Finally, the GETS user 104 will be connected to the destination number via the mobile communication device 102. During high stress responses to manmade or natural disasters by first responders, the GETS call set up is prone to user error due to the 32+ digits that must be entered via the native dialer.

In accordance with configurations, the GETS user 104 opens the native SMS application 106 on their mobile communication device 102. The GETS user 104 then enters a short code, e.g., GETS (which is 4387 on a native dialer or keypad) as the destination number of a SMS message 108. In the SMS message body, the GETS user 104 enters the destination phone number of the party the GETS user 104 is attempting to reach.

An Internet Protocol (IP) short message (IPSM) SMS center (SMSC) 110 (SMSC 110 herein) receives and routes the SMS message 108 as a session initiation protocol (SIP) MESSAGE to a GETS application server 112 in the Internet Protocol Multimedia Subsystem (IMS) core 114. The GETS application server 112 extracts the originating phone number (e.g., the MDN of the mobile communication device 102 used to originate the SMS message 108) and the destination number from the body of the SMS message 108. Upon extracting the destination number, the GETS application server 112 initiates a SIP INVITE to the mobile communication device 102 originating the SMS message 108.

The GETS user 104 answers the call (based on the SIP INVITE) and receives an announcement that they are using GETS of the mobile operator's wireless communication network 100. After the announcement, the GETS user 104 may be prompted for their voice biometric passphrase 116 for user authentication. In configurations, the GETS user 104 may speak or annunciate any word(s) as the voice is what is being checked and not the specific words. The voice biometric passphrase 116 (or whatever word(s) the GETS user 104 speaks) is provided to a voice biometric engine 118. In configurations, the voice biometric passphrase 116 (or whatever word(s) the GETS user 104 speaks) is provided to the voice biometric engine 118 via the GETS application server 112.

The voice biometric engine 118 authenticates the GETS user 104 based on a voiceprint match of a previously recorded passphrase stored in a voiceprint database 124. Upon authentication, the GETS application server 112 looks up the GETS user's privileges in a PIN database 120 (which may be the same database that includes the voiceprint database 124) based on the mobile operator mobile directory number (MDN). In configurations, the GETS user 104 may be authenticated via some other means, e.g., a fingerprint, facial recognition, etc. Since the mobile operator of the wireless communication network 100 knows the phone number from which the GETS user is calling, the GETS application server 112 may look up the GETS user's privileges in the PIN database 120 based upon the mobile operator MDN.

If the GETS user has PIN privileges to dial the destination number, the GETS user receives a final announcement from the GETS application server 112. After the GETS application server 112 processes the destination number, the GETS user 104 may be connected, via the mobile communication device 102, to a communication device 126 associated with the desired destination number.

In configurations, the GETS user 104 may be preauthorized for a predetermined amount of time, e.g., for ten days. In some configurations, the preauthorization may be based upon, for example, a predicted natural disaster. For example, a hurricane might be predicted to hit portions of Florida. The GETS user 104 may be preauthorized for a predetermined amount of time required before, during and/or after the anticipated arrival of the hurricane. Based on such preauthorization, the GETS user 104 may just need to dial the desired destination number. In configurations, the preauthorization may be controlled via a defined geofence 122. For example, the defined geofence 122 may be defined for areas within the wireless communication network 100 affected by the anticipated hurricane. In order for the preauthorization to be enabled for the GETS user 104, the GETS user 104 and their mobile communication device 102 must be located within the defined geofence 122.

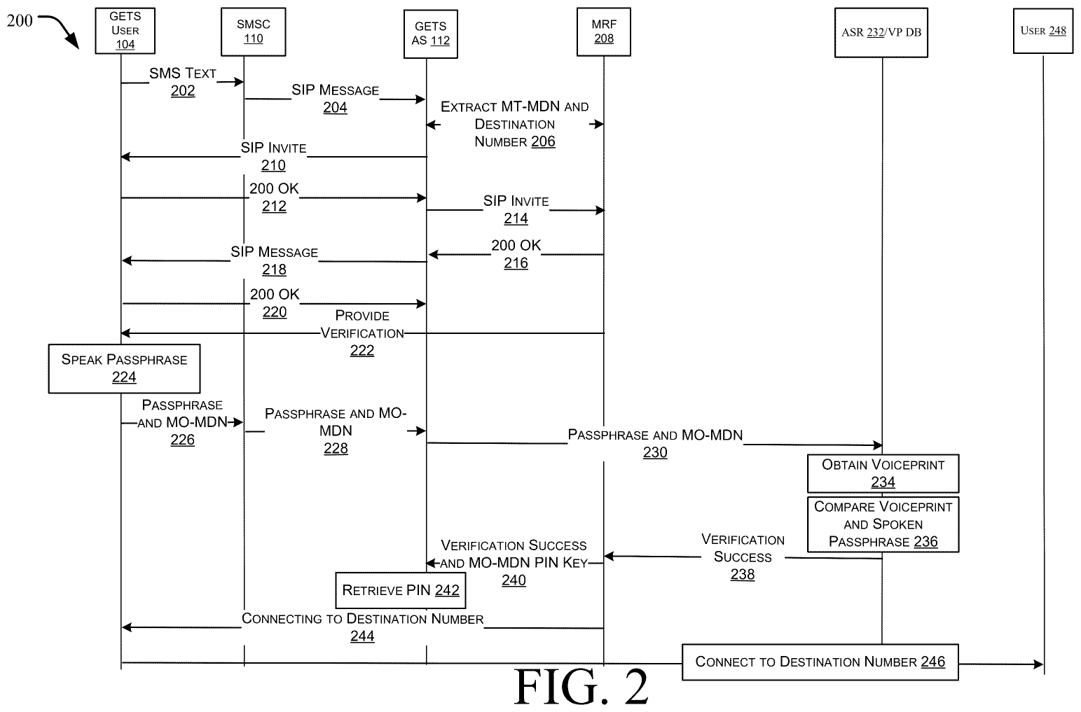

FIG. 2 is a flow diagram illustrating an example 200 of interfacing with an emergency telecommunications service such as, for example, Government Emergency Telecommunications Service (GETS), from a mobile communication device using a short message service (SMS) embedded application on the mobile communication device to initiate and optimize an emergency telecommunications service call set up.

At 202, the GETS user 104 opens the SMS application 106 on the mobile communication device 102 and sends a SMS text to the SMSC 110. The SMS text code may be, for example, (which is 4387 on a native dialer or keypad) and the body of the text includes the desired destination phone number for the GETS call.

At 204, the SMSC 110 routes the text message as a SIP MESSAGE to the GETS application server (AS) 112. At 206, the GETS application server 112, via a media resource function (MRF) 208, extracts the originating phone number (e.g., the mobile operator (MO) mobile terminated (MT) mobile directory number (MDN) (MT-MDN) of the mobile communication device 102 used to originate the SMS message) and the desired destination phone number. At 210, the GETS application server 112 initiates a SIP INVITE to the mobile communication device 102. At 212, the mobile communication device 102 provides a 200 OK acknowledgement message back to the GETS application server 112.

At 214, the GETS application server initiates a SIP INVITE to the MRF 208. At 216, the MRF 208 provides a 200 OK acknowledgement message to the GETS application server 112. At 218, the GETS application server 112 sends a SIP REINVITE message to the mobile communication device 102. At 220, the mobile communication device 102 provides a 200 OK acknowledgement message to the GETS application server 112.

At 222, the MRF 208 prompts the GETS user 104 for verification. For example, the MRF 208 may prompt the GETS user 104 to speak, e.g., enunciate words such as, the GETS user's passphrase. At 224, the GETS user 104 speaks the passphrase (or some other words). At 226, the passphrase and the MO-MDN are forwarded on to the SMSC 110. At 228, the passphrase and MO-MDN are forwarded to the GETS application server 112. At 230, the GETS application server 112 forwards the passphrase and MO-MDN to an automatic speech recognition component (ASR) 232. At 234, the ASR 232 obtains the GETS user's voiceprint on file from a voiceprint database (VP DB) shown with ASR 232 in FIG. 2). In configurations, the retrieved voiceprint may be obtained based upon the MDN. At 236, the ASR 234 compares the retrieved voiceprint and the passphrase spoken by the GETS user 104. In configurations, one or more of the MRF 208, the ASR 234, and/or the voiceprint database may be part of the GETS application server 112.

Upon successful comparison of the passphrase spoken by the GETS user 104 and the retrieved voiceprint, at 238 the ASR 234 provides a message of success to the MRF 208. At 240, the MRF 208 provides a success message and the MO-MDN PIN Key to the GETS application server 112. At 242, the GETS application server 112 retrieves a PIN from a PIN database within the GETS application server 112. The PIN indicates the privileges of the GETS user 104 and if the privileges indicate that the GETS user 104 is allowed to call the desired destination number, then the GETS application server 112 may play the destination number to the MRF 208. At 244, the MRF 208 provides a message or announcement to the GETS user 104 that GETS is connecting the GETS user 104 to the desired destination number. At 246, the GETS user 104 may be connected to the desired destination number, e.g., a call may be put through a user 248 associated with the desired destination number.

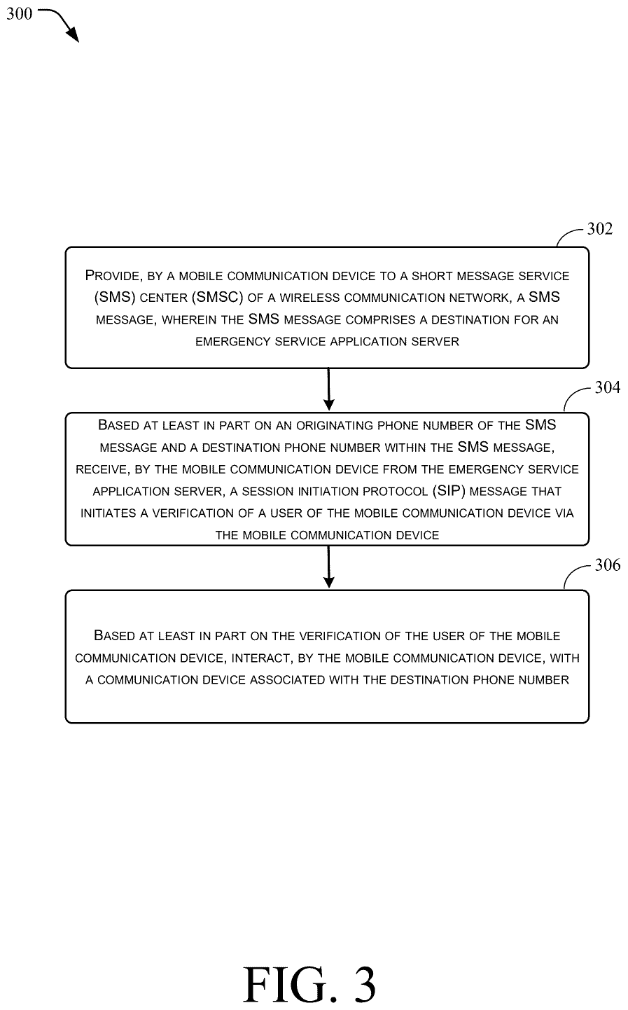

FIG. 3 is a flow diagram illustrating an example method for interfacing with an emergency telecommunications service such as, for example, Government Emergency Telecommunications Service (GETS), from a mobile communication device using a short message service (SMS) embedded application on the mobile communication device to initiate and optimize an emergency telecommunications service call set up. The process is illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, when executed by one or more processor(s), performs the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 3 is a flow diagram illustrating an example method 300 for interfacing with an emergency telecommunications service such as, for example, Government Emergency Telecommunications Service (GETS), from a mobile communication device using a short message service (SMS) embedded application on the mobile communication device to initiate and optimize an emergency telecommunications service call set up, according to some implementations.

At 302, a mobile communication device provides a SMS message to a short message service (SMS) center (SMSC) of a wireless communication network, wherein the SMS message comprises a destination for an emergency service application server. For example, the GETS user 104 opens the native SMS application 106 on their mobile communication device 102. The GETS user 104 then enters a short code, e.g., GETS (which is 4387 on a native dialer or keypad) as the destination number of a SMS message 108. In the SMS message body, the GETS user 104 enters the destination phone number of the party the GETS user 104 is attempting to reach.

At 304, based at least in part on an originating phone number of the SMS message and a destination phone number within the SMS message, the mobile communication device receives a session initiation protocol (SIP) message that initiates a verification of a user of the mobile communication device via the mobile communication device. For example, a SMS center (SMSC) 110 receives and routes the SMS message 108 as a session initiation protocol (SIP) MESSAGE to a GETS application server 112 in the Internet Protocol Multimedia Subsystem (IMS) core 114. The GETS application server 112 extracts the originating phone number (e.g., the MDN of the mobile communication device 102 used to originate the SMS message 108) and the destination number from the body of the SMS message 108. Upon extracting the destination number, the GETS application server 112 initiates a SIP INVITE (or RE-INVITE) to the mobile communication device 102 originating the SMS message 108. The GETS user 104 answers the call (based on the SIP INVITE or RE-INVITE) and receives an announcement that the GETS user 104 is using GETS of the mobile operator's wireless communication network 100. Furthermore, the SIP message may initiate a verification (e.g., biometric verification) of the user of the mobile communication device via the mobile communication device.

At 306, based at least in part on the verification of the user of the mobile communication device, the mobile communication device interacts with a communication device associated with the destination phone number. For example, after the announcement that the GETS user 104 is using GETS of the mobile operator's wireless communication network 100, the GETS user 104 may be prompted for their voice biometric passphrase 116 for user authentication. In configurations, the GETS user 104 may speak or annunciate any word(s) as the voice is what is being checked and not the specific words. The voice biometric passphrase 116 (or whatever word(s) the GETS user 104 speaks) is provided to a voice biometric engine 118. In configurations, the voice biometric passphrase 116 (or whatever word(s) the GETS user 104 speaks) is provided to the voice biometric engine 118 via the GETS application server 112.

The voice biometric engine 118 authenticates the GETS user 104 based on a voiceprint match of a previously recorded passphrase stored in a voiceprint database 124. Upon authentication, the GETS application server 112 looks up the GETS user's privileges in a PIN database 120 (which may be the same database that includes the voiceprint database 124) based on the mobile operator mobile directory number (MDN). In configurations, the GETS user 104 may be authenticated via some other means, e.g., a fingerprint, facial recognition, etc. Since the mobile operator of the wireless communication network 100 knows the phone number from which the GETS user is calling, the GETS application server 112 may look up the GETS user's privileges in the PIN database 120 based upon the mobile operator MDN.

If the GETS user has PIN privileges to dial the destination number, the GETS user receives a final announcement from the GETS application server 112. After the GETS application server 112 processes the destination number, the GETS user 104 may be connected, via the mobile communication device 102, to a communication device 126 associated with the desired destination number.

Thus, the techniques and architecture described herein allow a user to easily initiate a high priority call and use their voice to authenticate themselves by speaking a short passphrase, e.g., “I'm a GETS user.” The passphrase is biometrically compared to a pre-recorded passphrase to ensure authentication of the user based on a voiceprint of the user. The user also has the option of saying any phrase to match their biometric voiceprint. The characteristics of the user's voiceprint is evaluated for authenticity, not the actual spoke phrase. The techniques and architecture also provide all first responders using GETS an optional interface with an optimized call set-up solution. The goal of GETS is to “increase the probability of call completion during all conditions, i.e., network overloading.” The techniques and architecture provide a new innovative way to initiate a GETS call, thereby minimizing the interactions in authenticating the user through something unique to themselves, e.g., their voice.

Mobile communication devices 102 may be implemented as any suitable mobile computing device configured to communicate over a wireless and/or wireline network, including, without limitation, a mobile phone (e.g., a smart phone), a tablet computer, a laptop computer, a portable digital assistant (PDA), a wearable computer (e.g., electronic/smart glasses, a smart watch, fitness trackers, etc.), a networked digital camera, and/or similar mobile devices. Although this description predominantly describes the mobile communication devices 102 as being “mobile” (i.e., configured to be carried and moved around), it is to be appreciated that the mobile communication devices 102 may represent various types of communication devices that are generally stationary as well, such as televisions, desktop computers, game consoles, set top boxes, Internet of Things (IOT) devices, and the like. In this sense, the terms “communication device,” “wireless device,” “wireline device,” “mobile communication device,” “mobile device,” “computing device,” “portable electronic device,” and “user equipment (UE)” may be used interchangeably herein to describe any communication device capable of performing the techniques described herein. Furthermore, the portable mobile communication devices 102 may be capable of communicating over wired networks, and/or wirelessly using any suitable wireless communications/data technology, protocol, or standard, such as Global System for Mobile Communications (GSM), Time Division Multiple Access (TDMA), Universal Mobile Telecommunications System (UMTS), Evolution-Data Optimized (EVDO), Long Term Evolution (LTE), Advanced LTE (LTE+), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VOIP), Voice over LTE (VOLTE), 5G, IEEE 802.1x protocols, WiMAX, Wi-Fi, and/or any future IP-based network technology or evolution of an existing IP-based network technology.

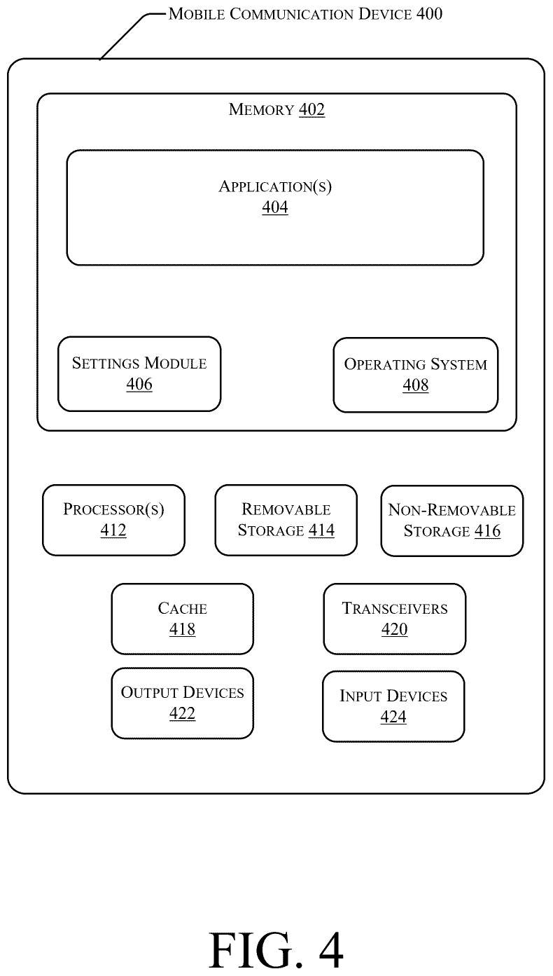

FIG. 4 schematically illustrates a component level view of a mobile communication device 400, such as mobile communication device 102, configured to function within wireless communication networks. As illustrated, the mobile communication device 400 comprises a system memory 402, e.g., computer-readable media, storing application(s) 404, e.g., a SMS application 106 that implements functions and UIs as described herein. Alternatively, the functions and UIs may be implemented, wholly or in part, via firmware (not illustrated). The mobile communication device 400 also comprises a settings module 406, and an operating system 408. Also, the mobile communication device 400 includes processor(s) 412, a removable storage 414, a non-removable storage 416, cache 418, transceivers 420, output device(s) 422, and input device(s) 424. In various implementations, system memory 402 is volatile (such as RAM), non-volatile (such as ROM, flash memory, etc.) or some combination of the two. In some implementations, the processor(s) 412 is a central processing unit (CPU), a graphics processing unit (GPU), or both CPU and GPU, or any other sort of processing unit.

The mobile communication device 400 may also include additional data storage devices (removable and/or non-removable) such as, for example, magnetic disks, optical disks, or tape. Such additional data storage may include removable storage 414 and non-removable storage 416. Additionally, the mobile communication device 400 includes cache 418.

Non-transitory computer-readable media may include volatile and nonvolatile, removable and non-removable tangible, physical media implemented in technology for storage of information, such as computer readable instructions, data structures, program modules, or other data. System memory 402, removable storage 414, non-removable storage 416 and cache 418 are all examples of non-transitory computer-readable media. Non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other tangible, physical medium which can be used to store the desired information and which can be accessed by the mobile communication device 400. Any such non-transitory computer-readable media may be part of the mobile communication device 400. The processor(s) 412 may be configured to execute instructions, which may be stored in the non-transitory computer-readable media or in other computer-readable media accessible to the processor(s) 412.

In some implementations, the transceivers 420 include any sort of transceivers known in the art. For example, the transceivers 420 may include a radio transceiver that performs the function of transmitting and receiving radio frequency communications via an antenna (not shown). Also, or alternatively, the transceivers 420 may include wireless modem(s) to facilitate wireless connectivity with other computing devices. Further, the transceivers 420 may include wired communication components, such as an Ethernet port, for communicating with other networked devices.

In some implementations, the output devices 422 include any sort of output devices known in the art, such as a display (e.g., a liquid crystal display), speakers, a vibrating mechanism, or a tactile feedback mechanism. Output devices 422 also include ports for one or more peripheral devices, such as headphones, peripheral speakers, or a peripheral display.

In various implementations, input devices 424 include any sort of input devices known in the art. For example, input devices 424 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like. The input devices 424 may be used to enter preferences of a user of the mobile communication device 400 to define how the user wishes certain calls from third parties to be handled by the wireless communication network, as previously described herein.

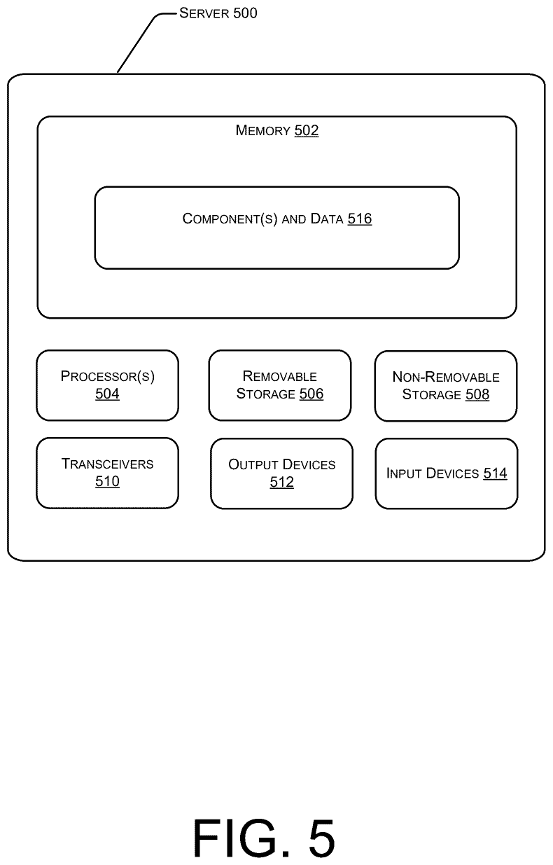

FIG. 5 schematically illustrates a component level view of a server 500 configured for use within a wireless communication network, e.g., wireless communication network 100, in order to provide various services within the wireless communication network, according to the techniques described herein. For example, the server 500 may serve as a GETS application server 112, e.g., one or more servers 500 may be configured to serve as GETS application server 112. As another example, the server 500 may serve as a SMSC 110, e.g., one or more servers 500 may be configured to serve as a SMSC 110.

As illustrated, the server 500 comprises a system memory 502 that may store one or more components and/or applications and data 516 for interacting with mobile communication devices, e.g., mobile communication device 102, as described herein. Also, the server 500 may include processor(s) 504, a removable storage 506, a non-removable storage 508, transceivers 510, output device(s) 512, and input device(s) 514.

In various implementations, system memory 502 is volatile (such as RAM), non-volatile (such as ROM, flash memory, etc.), or some combination of the two. In some implementations, the processor(s) 504 is a Central Processing Unit (CPU), a Graphics Processing Unit (GPU), or both CPU and GPU, or any other sort of processing unit.

The server 500 may also include additional data storage devices (removable and/or non-removable) such as, for example, magnetic disks, optical disks, or tape. Such additional storage is illustrated in FIG. 5 by removable storage 506 and non-removable storage 508. The one or more of the memory 502, the removable storage 506 and/or the non-removable storage 508 may include module(s) and data 516 (illustrated in the memory 502). The module(s) and data 516 may include instructions executable by, for example, the processor(s) 504.

Non-transitory computer-readable media may include volatile and nonvolatile, removable and non-removable tangible, physical media implemented in technology for storage of information, such as computer readable instructions, data structures, program modules, or other data. System memory 502, removable storage 506 and non-removable storage 508 are all examples of non-transitory computer-readable media. Non-transitory computer-readable media include, but are not limited to, RAM, ROM, EEPROM, flash memory or other memory technology, CD-ROM, Digital Versatile Disks (DVD) or other optical storage, magnetic cassettes, magnetic tape, magnetic disk storage or other magnetic storage devices, or any other tangible, physical medium which can be used to store the desired information and which can be accessed by the server 500. Any such non-transitory computer-readable media may be part of the server 500.

In some implementations, the transceivers 510 include any sort of transceivers known in the art. For example, the transceivers 510 may include wired communication components, such as an Ethernet port, for communicating with other networked devices. Also, or instead, the transceivers 510 may include wireless modem(s) to facilitate wireless connectivity with other computing devices. Further, the transceivers 510 may include a radio transceiver that performs the function of transmitting and receiving radio frequency communications via an antenna.

In some implementations, the output devices 512 include any sort of output devices known in the art, such as a display (e.g., a liquid crystal display), speakers, a vibrating mechanism, or a tactile feedback mechanism. Output devices 512 also include ports for one or more peripheral devices, such as headphones, peripheral speakers, or a peripheral display.

In various implementations, input devices 514 include any sort of input devices known in the art. For example, input devices 514 may include a camera, a microphone, a keyboard/keypad, a computer mouse, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

Some or all operations of the processes described above can be performed by execution of computer-readable instructions stored on a computer storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer storage media may include volatile memory (such as random access memory (RAM)) and/or non-volatile memory (such as read-only memory (ROM), flash memory, etc.). The computer storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer storage medium is an example of computer-readable media. Computer-readable media includes at least two types of computer-readable media, namely computer storage media and communications media. Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer storage media do not include communication media.

The computer-readable instructions stored on one or more non-transitory computer storage media that, when executed by one or more processors, may perform operations described above with reference to FIGS. 1-3. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
providing, by a mobile communication device to a short message service (SMS) center (SMSC) of a wireless communication network, a SMS message, wherein the SMS message comprises a destination for an emergency service application server;
based at least in part on an originating phone number of the SMS message and a destination phone number within the SMS message, receiving, by the mobile communication device from the emergency service application server, a session initiation protocol (SIP) message that initiates a verification of a user of the mobile communication device via the mobile communication device; and
based at least in part on the verification of the user of the mobile communication device, interacting, by the mobile communication device, with a communication device associated with the destination phone number.

2. The method of claim 1, wherein the emergency service application server is part of Government Emergency Telecommunications Service (GETS).

3. The method of claim 2, further comprising:
in response to the SIP message, receiving, by the mobile communication device, an announcement indicating the mobile communication device is accessing GETS of an operator of the wireless communication network.

4. The method of claim 1, wherein verification of the user of the mobile communication device comprises comparison of a voice of the user with a passphrase previously recorded by the user.

5. The method of claim 4, wherein comparison of the voice of the user with the passphrase previously recorded by the user comprises comparison of the passphrase previously recorded by the user with words annunciated by the user in response to at least an announcement indicating the mobile communication device is accessing Government Emergency Telecommunications Service (GETS) of an operator of the wireless communication network.

6. The method of claim 5, wherein the words annunciated by the user in response to at least the announcement comprises the passphrase.

7. The method of claim 1, wherein interacting, by the mobile communication device, with the communication device associated with the destination phone number is further based at least in part on privileges associated with an authentication code associated with the user.

8. The method of claim 1, further comprising:
preauthorizing the mobile communication device for a predetermined amount of time for interaction of the mobile communication device with the destination phone number.

9. The method of claim 8, wherein preauthorization of the mobile communication device is only valid within a predefined geofence of the wireless communication network.

10. A system comprising:
one or more processors; and
one or more non-transitory computer-readable media storing computer-executable instructions that, when executed by the one or more processors, cause the one or more processors to perform actions comprising:
providing, by a mobile communication device to a message service center (MSC) of a wireless communication network, a text message, wherein the text message comprises a destination for an emergency service application server;
based at least in part on an originating phone number of the text message and a destination phone number within the text message, receiving, by the mobile communication device from the emergency service application server, a session initiation protocol (SIP) message that initiates a verification of a user of the mobile communication device via the mobile communication device; and
based at least in part on the verification of the user of the mobile communication device, interacting, by the mobile communication device, with a communication device associated with the destination phone number.

11. The system of claim 10, wherein the emergency service application server is part of Government Emergency Telecommunications Service (GETS).

12. The system of claim 11, wherein the actions further comprise:
in response to the SIP message, receiving, by the mobile communication device, an announcement indicating the mobile communication device is accessing GETS of an operator of the wireless communication network.

13. The system of claim 10, wherein verification of the user of the mobile communication device comprises comparison of a voice of the user with a passphrase previously recorded by the user.

14. The system of claim 13, wherein comparison of the voice of the user with the passphrase previously recorded by the user comprises comparison of the passphrase previously recorded by the user with words annunciated by the user in response to at least an announcement indicating the mobile communication device is accessing Government Emergency Telecommunications Service (GETS) of an operator of the wireless communication network.

15. The system of claim 14, wherein the words annunciated by the user in response to at least the announcement comprises the passphrase.

16. The system of claim 10, wherein interacting, by the mobile communication device, with the communication device associated with the destination phone number is further based at least in part on privileges associated with an authentication code associated with the user.

17. The system of claim 10, wherein the actions further comprise:
preauthorizing the mobile communication device for a predetermined amount of time for interaction of the mobile communication device with the destination phone number.

18. The system of claim 17, wherein preauthorization of the mobile communication device is only valid within a predefined geofence of the wireless communication network.

19. A method comprising:
providing, by a mobile communication device to a message service center (MSC) of a wireless communication network, a text message, wherein the text message comprises a destination for an emergency service application server, wherein the emergency service application server is part of Government Emergency Telecommunications Service (GETS);
based at least in part on an originating phone number of the text message and a destination phone number within the text message, receiving, by the mobile communication device from the emergency service application server, a session initiation protocol (SIP) message that initiates a verification of a user of the mobile communication device via the mobile communication device;
in response to the SIP message, receiving, by the mobile communication device, an announcement indicating the mobile communication device is accessing GETS of an operator of the wireless communication network; and
based at least in part on the verification of the user of the mobile communication device, interacting, by the mobile communication device, with a communication device associated with the destination phone number, wherein verification of the user of the mobile communication device comprises comparison of a voice of the user with a passphrase previously recorded by the user.

20. The method of claim 19, wherein comparison of the voice of the user with the passphrase previously recorded by the user comprises comparison of the passphrase previously recorded by the user with words annunciated by the user in response to at least the announcement.
